(19) United States
(12) Patent Application Publication
(10) Pub. No.: US 2026/0012920 A1
(43) Pub. Date: Jan. 8, 2026

(54) Wireless Communication Methods, Terminal Devices and Network Devices

(71) Applicant: GUANGDONG OPPO MOBILE TELECOMMUNICATIONS CORP., LTD., Dongguan (CN)

(72) Inventors: Yang LIU, Dongguan (CN); Xinlei YU, Dongguan (CN)

(73) Assignee: GUANGDONG OPPO MOBILE TELECOMMUNICATIONS CORP., LTD., Dongguan (CN)

(21) Appl. No.: 19/329,320

(22) Filed: Sep. 15, 2025

Related U.S. Application Data
(63) Continuation of application No. PCT/CN2023/084029, filed on Mar. 27, 2023.

(51) Int. Cl. H04W 64/00; H04W 92/18

(52) U.S. Cl. CPC H04W 64/00; H04W 92/18

(57) ABSTRACT

Wireless communication methods, terminal devices, and network devices are provided. A method include: when a first condition is satisfied, a terminal device reselects an anchor terminal used for sidelink positioning and/or a service terminal used for determining a positioning result. The method may further include: determining, based on first information, whether to reselect the anchor terminal used for sidelink positioning and/or the serving terminal used to determine the positioning result.

### CROSS-REFERENCE TO RELATED APPLICATIONS

This application is a continuation of International Application No. PCT/CN2023/084029, filed on Mar. 27, 2023, the disclosure of which is hereby incorporated by reference in its entirety.

### TECHNICAL FIELD

Embodiments of this application relate to the communications field, and in particular, to a wireless communication method, a terminal device, and a network device.

### BACKGROUND

In a new radio (NR) system, a terminal (or referred to as a to-be-positioned terminal) that has a positioning need may be positioned by using a sidelink. For example, an anchor terminal may measure a sidelink positioning reference signal transmitted by the to-be-positioned terminal, to implement sidelink positioning, or the to-be-positioned terminal may measure a sidelink positioning reference signal transmitted by the anchor terminal, to implement sidelink positioning. A specific positioning result may be derived by the to-be-positioned terminal or a serving terminal based on a measurement result of the sidelink positioning reference signal.

However, a network environment is complicated and changeable. How to ensure performance of sidelink positioning is an urgent problem to be resolved.

### SUMMARY

Embodiments of this application provide a wireless communication method and a terminal device, which are conducive to ensuring performance of sidelink positioning.

According to a first aspect, a wireless communication method is provided, including: in a case in which a first condition is met, reselecting, by a terminal device, an anchor terminal used for sidelink positioning and/or a serving terminal used to determine a positioning result.

According to a second aspect, a wireless communication method is provided, including: transmitting, by a network device, first configuration information to a terminal device, where the first configuration information is used to configure a reselection parameter of an anchor terminal and/or a reselection parameter of a serving terminal.

According to a third aspect, a terminal device is provided and is configured to execute the method according to the first aspect or implementations of the first aspect.

Specifically, the terminal device includes a functional module configured to execute the method according to the first aspect or implementations of the first aspect.

According to a fourth aspect, a network device is provided and is configured to execute the method according to the second aspect or implementations of the second aspect.

Specifically, the network device includes a functional module configured to execute the method according to the second aspect or implementations of the second aspect.

According to a fifth aspect, a terminal device is provided, including a processor and a memory. The memory is configured to store a computer program, and the processor is configured to invoke and run the computer program stored in the memory, to execute the method according to the first aspect or implementations of the first aspect.

According to a sixth aspect, a network device is provided, including a processor and a memory. The memory is configured to store a computer program, and the processor is configured to invoke and run the computer program stored in the memory, to execute the method according to the second aspect or implementations of the second aspect.

According to a seventh aspect, a chip is provided and is configured to implement the method according to any one of the first aspect and the second aspect or implementations of the first aspect and the second aspect.

Specifically, the chip includes a processor, configured to invoke a computer program from a memory and run the computer program, so that a device on which the apparatus is installed executes the method according to any one of the first aspect and the second aspect or implementations of the first aspect and the second aspect.

According to an eighth aspect, a computer-readable storage medium is provided, and is configured to store a computer program, where the computer program causes a computer to execute the method according to any one of the first aspect and the second aspect or the implementations of the first aspect and the second aspect.

According to a ninth aspect, a computer program product is provided, including computer program instructions, where the computer program instructions cause a computer to execute the method according to any one of the first aspect and the second aspect or implementations of the first aspect and the second aspect.

According to a tenth aspect, a computer program is provided, and when the computer program runs on a computer, the computer executes the method according to any one of the first aspect and the second aspect or implementations of the first aspect and the second aspect.

### BRIEF DESCRIPTION OF DRAWINGS

FIG. 1 is a schematic diagram of an application scenario according to an embodiment of this application.

FIG. 2 is a schematic diagram of one type of out-of-coverage sidelink positioning according to this application.

FIG. 3 is a schematic diagram of another type of out-of-coverage side positioning according to this application.

FIG. 4 is a schematic diagram of a wireless communication method according to an embodiment of this application.

FIG. 5 is a schematic block diagram of a terminal device according to an embodiment of this application.

FIG. 6 is a schematic block diagram of a network device according to an embodiment of this application.

FIG. 7 is a schematic block diagram of a communications device according to an embodiment of this application.

FIG. 8 is a schematic block diagram of a chip according to an embodiment of this application.

FIG. 9 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, a global system for mobile communications (GSM), a code division multiple access (CDMA) system, a wideband code division multiple access (WCDMA) system, general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), wireless fidelity (WiFi), a fifth-generation (5th-Generation, 5G) system, or another communications system.

Generally, a quantity of connections supported by a conventional communications system is limited and is also easy to implement. However, with development of communications technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

Optionally, a communications system in embodiments of this application may be applied to a carrier aggregation (CA) scenario, a dual connectivity (DC) scenario, or a standalone (SA) networking scenario.

Optionally, the communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a non-shared spectrum.

Embodiments of this application are described with reference to a network device and a terminal device. The terminal device may also be referred to as a user equipment (UE), an access terminal, a subscriber unit, a subscriber station, a mobile site, a mobile station, a remote station, a remote terminal, a mobile device, a user terminal, a terminal, a wireless communications device, a user agent, a user apparatus, or the like.

The terminal device may be a station (STATION, STA) in a WLAN, a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, a terminal device in a future evolved public land mobile network (PLMN), or the like.

In embodiments of this application, the terminal device may be deployed on land, including being indoors or outdoors, handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (Virtual Reality, VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, or the like.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device also implements a powerful function through software support, data interaction, and cloud interaction. In a broad sense, the wearable smart device includes a full-featured and large-sized device that may implement all or some functions without relying on a smartphone, for example, a smart watch or smart glasses, and a device that only focus on a specific type of application function and needs to be used in cooperation with another device such as a smartphone, for example, various smart bracelets and smart jewelries for physical sign monitoring.

In embodiments of this application, the network device may be a device configured to communicate with a mobile device. The network device may be an access point (AP) in a WLAN, a base transceiver station (BTS) in GSM or CDMA, a Node B (NodeB, NB) in WCDMA, an evolved Node B (eNB, or eNodeB) in LTE, a relay station or an access point, a vehicle-mounted device, a wearable device, a network device (gNB) in an NR network, a network device in a future evolved PLMN network, a network device in an NTN network, or the like.

By way of example rather than limitation, in embodiments of this application, the network device may have a mobility characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of small coverage and low transmit power, and are applicable to providing a high-rate data transmission service.

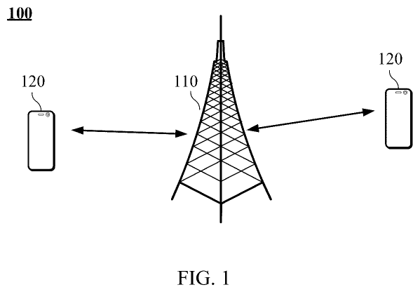

For example, FIG. 1 shows a communications system 100 to which embodiments of this application are applied. The communications system 100 may include a network device 110, and the network device 110 may be a device that communicates with a terminal device 120 (or referred to as a communications terminal or a terminal). The network device 110 may provide communication coverage in a specific geographic area, and may communicate with a terminal device located in the coverage area.

FIG. 1 exemplarily shows one network device and two terminal devices. Optionally, the communications system 100 may include a plurality of network devices, and another quantity of terminal devices may be included in coverage of each network device, which is not limited in embodiments of this application.

Optionally, the communications system 100 may further include another network entity such as a network controller or a mobility management entity. This is not limited in embodiments of this application.

It should be understood that, in embodiments of this application, a device that has a communication function in a network or system may be referred to as a communications device. The communications system 100 shown in FIG. 1 is used as an example. The communications device may include the network device 110 and the terminal device 120 that have a communication function. The network device 110 and the terminal device 120 may be the foregoing specific devices, and details are not described herein again. The communications device may further include another device in the communications system 100, for example, another network entity such as a network controller or a mobility management entity, which is not limited in embodiments of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, the “indication” mentioned in embodiments of this application may be a direct indication or an indirect indication, or indicate an association. For example, if A indicates B, it may mean that A directly indicates B, for example, B may be acquired from A. Alternatively, it may mean that A indicates B indirectly, for example, A indicates C, and B may be acquired from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” may be implemented by prestoring corresponding code or a corresponding table in a device (for example, including the terminal device and the network device) or in other manners that may be used for indicating related information, and a specific implementation thereof is not limited in this application. For example, being pre-defined may refer to being defined in a protocol.

In embodiments of this application, the “protocol” may be a standard protocol in the communications field, which may include, for example, an LTE protocol, an NR protocol, and a related protocol applied to a future communications system. This is not limited in this application.

To understand embodiments of this application, sidelink positioning related to this application is described.

Sidelink positioning serves as a supplement to 5G positioning that is conventionally dependent on a terminal device and a network device (for example, a TRP), and additionally uses a measurement result of a reference signal between terminal devices to complete positioning. For sidelink positioning, the reference signal should be transmitted and measured in a specified sidelink frequency band. The measurement result should reflect positioning reference variables with actual physical significance in space, such as a relative distance and a relative angle between the terminals. After sidelink positioning is triggered, a terminal device that has a positioning need first needs to search for a proper anchor device through network allocation or measurement of a surrounding signal by the terminal device. Then, the terminal device that has the positioning need measures a reference signal transmitted by the anchor device, and/or the anchor device measures a reference signal transmitted by the terminal device that has the positioning need, to obtain a positioning measurement result and derive a positioning result.

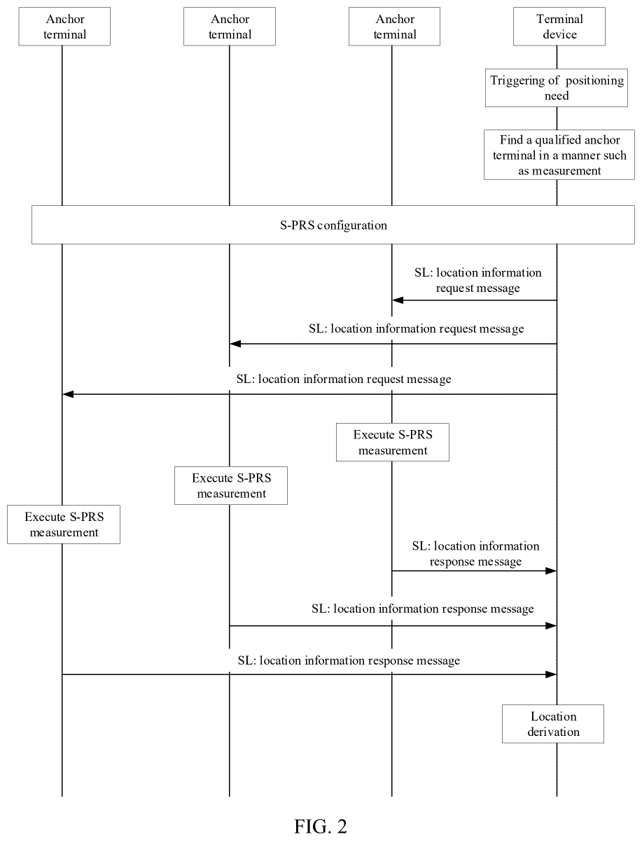

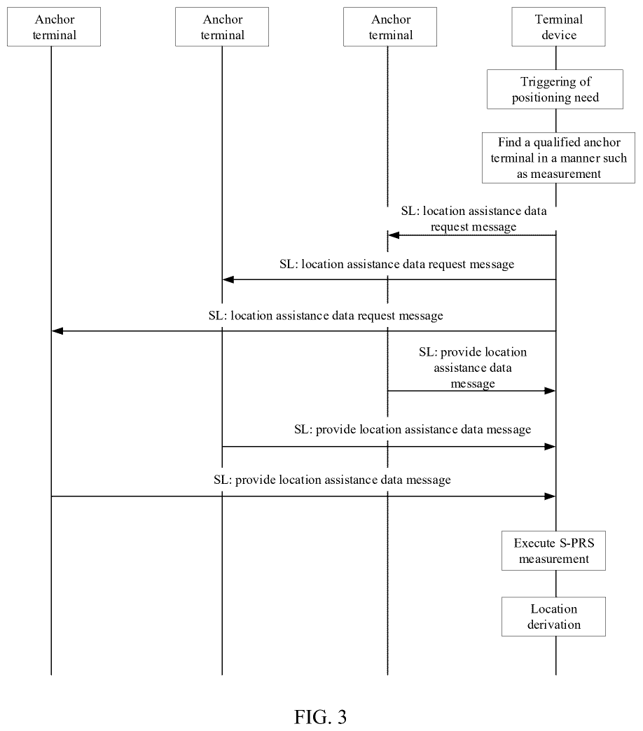

In some embodiments, FIG. 2 and FIG. 3 show schematic procedures of sidelink positioning in a scenario of network out-of-coverage communication. FIG. 2 shows a positioning procedure based on transmitting a sidelink positioning reference signal (SL-PRS) by a UE (or referred to as a to-be-positioned terminal) that has a positioning need, and FIG. 3 shows a positioning procedure based on transmitting a sidelink positioning reference signal by an anchor terminal.

In FIG. 2 and FIG. 3, if the to-be-positioned terminal acquires configuration information of the positioning reference signal of the anchor terminal from only ProvideLocationAssistanceData signalling and location information of the anchor terminal can be learned, the to-be-positioned terminal can complete the positioning.

It should be understood that, in the examples shown in FIG. 2 and FIG. 3, a positioning result may be derived by the to-be-positioned terminal based on a measurement result of the sidelink positioning reference signal, or may be derived by a dedicated serving terminal. For example, a party (for example, the anchor terminal or the to-be-positioned terminal) that executes measurement on the sidelink positioning reference signal may transmit the measurement result to the serving terminal, and the serving terminal derives the positioning result based on the measurement result.

In actual application, because a network environment is complicated and changeable, performance of sidelink positioning may be affected if the to-be-positioned terminal always performs sidelink positioning based on the fixed anchor terminal or the fixed serving terminal. How to ensure performance of sidelink positioning is an urgent problem to be resolved.

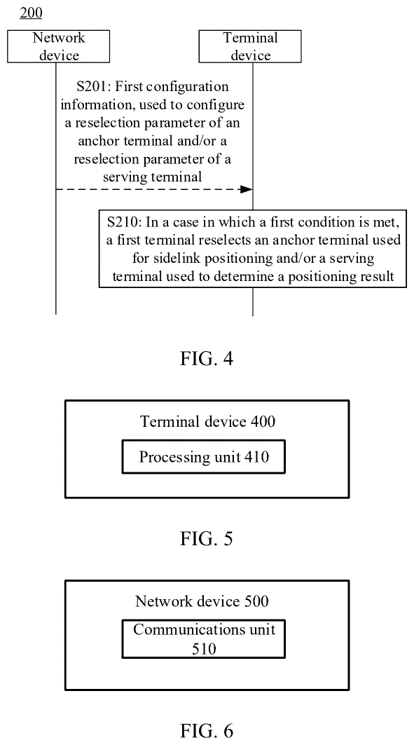

FIG. 4 is a schematic diagram of interaction in a wireless communication method 200 according to an embodiment of this application. As shown in FIG. 4, the method 200 may include at least a part of the following content.

S210: In a case in which a first condition is met, a terminal device reselects an anchor terminal and/or a serving terminal.

That is, in this embodiment of this application, the terminal device may reselect an anchor terminal and/or a serving terminal under a specific condition, which is conducive to ensuring performance of sidelink positioning.

In this embodiment of this application, the “anchor terminal” may also be referred to as an “anchor device”, a “roadside unit (Road Side Unit, RSU)”, “another terminal”, or a “relay terminal”, which is not limited in this application.

In this embodiment of this application, the anchor terminal may be a device that is configured to assist the terminal in positioning and that may transmit a sidelink positioning reference signal on a sidelink or measure a received sidelink positioning reference signal.

Optionally, the anchor terminal may communicate with the terminal device by using a PC5 interface.

In this embodiment of this application, the serving terminal may be a device configured to derive a positioning result and/or configure a sidelink positioning reference signal resource.

Optionally, the serving terminal may communicate with the terminal device by using a PC5 interface.

In some embodiments, the sidelink positioning reference signal may be an SL-PRS, or may be another reference signal used for sidelink positioning. This is not limited in embodiments of this application.

In some embodiments of this application, the method 200 further includes: determining, by the terminal device based on first information, whether to trigger reselection of an anchor terminal and/or a serving terminal.

In some embodiments, the first information may be used to assist in determining whether an anchor terminal currently used by the terminal device is qualified for sidelink positioning, and/or whether a serving terminal currently used by the terminal device is still qualified for positioning result derivation and/or sidelink positioning reference signal configuration.

In some embodiments, the terminal device may determine whether to trigger reselection of an anchor terminal, based on at least one of quality of a signal between the terminal device and the currently used anchor terminal, a distance between the terminal device and the currently used anchor terminal, information about movement between the terminal device and the currently used anchor terminal, or capability information of the currently used anchor terminal.

In some embodiments, the terminal device may determine whether to trigger reselection of a serving terminal, based on at least one of quality of a signal between the terminal device and the currently used serving terminal, a distance between the terminal device and the currently used serving terminal, information about movement between the terminal device and the currently used serving terminal, or capability information of the currently used serving terminal.

In some embodiments, the first information includes but is not limited to at least one of the following:
quality information of a channel between the terminal device and a first anchor terminal;
quality information of a channel between the terminal device and a first serving terminal;
information about a distance between the terminal device and the first anchor terminal;
information about a distance between the terminal device and the first serving terminal;
information about movement between the terminal device and the first anchor terminal;
information about movement between the terminal device and the first serving terminal;
capability information or capability change information of the first anchor terminal; or
capability information or capability change information of the first serving terminal.

For example, the terminal device may determine, based on the first information, whether the currently used anchor terminal and/or the currently used serving terminal are qualified for respective roles, thereby determining whether to trigger reselection of an anchor terminal and/or a serving terminal, which is conducive to ensuring performance of sidelink positioning.

In some embodiments, the determining, based on the first information, whether to reselect an anchor terminal may include:
determining whether to reselect an anchor terminal based on at least one of the following information:
quality information of a channel between the terminal device and a first anchor terminal;
information about a distance between the terminal device and the first anchor terminal;
information about movement between the terminal device and the first anchor terminal; or
capability information or capability change information of the first anchor terminal.

For example, the terminal device may determine, based on the first information, whether the currently used anchor terminal is qualified for the role of anchor terminal, thereby determining whether to trigger reselection of an anchor terminal, which is conducive to ensuring performance of sidelink positioning.

In some embodiments, the determining, based on the first information, whether to reselect a serving terminal may include:
determining whether to reselect a serving terminal based on at least one of the following information:
quality information of a channel between the terminal device and a first serving terminal;
information about a distance between the terminal device and the first serving terminal;
information about movement between the terminal device and the first serving terminal; or
capability information or capability change information of the first serving terminal.

For example, the terminal device may determine, based on the first information, whether the currently used serving terminal is qualified for the role of serving terminal, thereby determining whether to trigger reselection of a serving terminal, which is conducive to ensuring performance of sidelink positioning.

In some embodiments, the first anchor terminal is an anchor terminal that is currently used by the terminal device for sidelink positioning, or in other words, an anchor terminal that currently assists the terminal device in performing sidelink positioning.

In some embodiments, the first serving terminal is a serving terminal that is currently used by the terminal device to determine a positioning result and/or configure a sidelink positioning reference signal resource, or in other words, a serving terminal that currently provides the terminal device with a function of deriving a position and/or a function of configuring a sidelink positioning reference signal resource.

It should be understood that quality information of a channel in this embodiment of this application may include but is not limited to at least one of the following:
reference signal received power (RSRP), reference signal received quality (RSRQ), a signal-to-interference-plus-noise ratio (SINR), or a received signal strength indicator (RSSI).

For example, the quality information of the channel between the terminal device and the first anchor terminal may include at least one of the following:
RSRP, RSRQ, an SINR, or an RSSI between the terminal device and the first anchor terminal.

For example, the quality information of the channel between the terminal device and the first serving terminal may include at least one of the following:
RSRP, RSRQ, an SINR, or an RSSI between the terminal device and the first serving terminal.

In some embodiments, the information about movement between the terminal device and the first anchor terminal includes at least one of the following:
information about a moving direction between the terminal device and the first anchor terminal, for example, a relative moving direction between the terminal device and the first anchor terminal; or
information about a moving speed between the terminal device and the first anchor terminal, for example, a relative moving speed between the terminal device and the first anchor terminal.

In some embodiments, the information about movement between the terminal device and the first serving terminal includes at least one of the following:
information about a moving direction between the terminal device and the first serving terminal, for example, a relative moving direction between the terminal device and the first serving terminal; or
information about a moving speed between the terminal device and the first serving terminal, for example, a relative moving speed between the terminal device and the first serving terminal.

In some embodiments, the capability information or the capability change information of the first anchor terminal includes:
whether the first anchor terminal supports a role of anchor terminal.

For example, when the first anchor terminal does not support at least one function (for example, does not support providing location information) of the role of anchor terminal, it may be considered that the first anchor terminal does not support the role of anchor terminal.

As an example, whether the first anchor terminal supports the role of anchor terminal includes but is not limited to at least one of the following:
whether the first anchor terminal supports providing location information of the first anchor terminal, for example, for a reason, a location of the first anchor terminal is confidential;
whether the first anchor terminal supports measuring or receiving a sidelink positioning reference signal transmitted by the terminal device; or
whether the first anchor terminal supports transmitting a sidelink positioning reference signal to be measured or received by the terminal device.

In some embodiments, the first anchor terminal may transmit, to the terminal device, the capability information of the first anchor terminal or the capability change information of the first anchor terminal. The capability change information herein may be a change in a current capability of the first anchor terminal relative to a capability that is reported last time, so that the terminal device may determine, based on the capability information of the first anchor terminal or the capability change information of the first anchor terminal, whether the first anchor terminal still supports the role of anchor terminal.

In some embodiments, the capability information or the capability change information of the first serving terminal includes:
whether the first serving terminal supports a role of serving terminal.

For example, when the first serving terminal does not support at least one function (for example, does not support providing a function of deriving a location) of the role of serving terminal, it may be considered that the first serving terminal does not support the role of serving terminal.

As an example, whether the first serving terminal supports the role of serving terminal includes but is not limited to at least one of the following:
whether the first serving terminal supports providing a function of calculating a positioning result; or
whether the first serving terminal supports allocating or configuring an SL-PRS resource.

In some embodiments, the first serving terminal may transmit, to the terminal device, the capability information of the first serving terminal or the capability change information of the first serving terminal. The capability change information herein may be a change in a current capability of the first serving terminal relative to a capability that is reported last time, so that the terminal device may determine, based on the capability information of the first serving terminal or the capability change information of the first serving terminal, whether the first serving terminal still supports the role of serving terminal.

In some embodiments, the first condition may indicate that the anchor terminal currently used by the terminal device is no longer qualified for the role of anchor terminal, and/or the serving terminal currently used by the terminal device is no longer qualified for the role of serving terminal.

For example, when the anchor terminal currently used by the terminal device is no longer qualified for the role of anchor terminal, reselection of an anchor terminal is triggered, and/or when the serving terminal currently used by the terminal device is no longer qualified for the role of serving terminal, reselection of a serving terminal is triggered.

In some embodiments, it may be considered that the anchor terminal (that is, the first anchor terminal) currently used by the terminal device is no longer qualified for the role of anchor terminal in a case in which at least one of the following conditions is met:
the quality of the channel between the terminal device and the first anchor terminal is poor to a specific extent, for example, being lower than a specific threshold;
the distance between the terminal device and the first anchor terminal is long to a specific extent, for example, being greater than a specific threshold;
a moving trend between the terminal device and the first anchor terminal is being increasingly far from each other, for example, the relative moving speed is greater than a specific threshold; or
the first anchor terminal does not support the role of anchor terminal.

In some embodiments, it may be considered that the serving terminal (that is, the first serving terminal) currently used by the terminal device is no longer qualified for the role of serving terminal in a case in which at least one of the following conditions is met:
the quality of the channel between the terminal device and the first serving terminal is poor to a specific extent, for example, being lower than a specific threshold;
the distance between the terminal device and the first serving terminal is long to a specific extent, for example, being greater than a specific threshold;
a moving trend between the terminal device and the first serving terminal is being increasingly far from each other, for example, the relative moving speed is greater than a specific threshold; or
the first serving terminal does not support the role of serving terminal.

In some embodiments of this application, the first condition includes at least one of the following:
quality of a channel between the terminal device and a first anchor terminal meets a preset condition;
quality of a channel between the terminal device and a first serving terminal meets a preset condition;
a distance between the terminal device and the first anchor terminal is greater than a first distance threshold;
a distance between the terminal device and the first serving terminal is greater than a second distance threshold;
information about movement between the terminal device and the first anchor terminal meets a first preset condition;
information about movement between the terminal device and the first serving terminal meets a second preset condition;
the first anchor terminal does not support the role of anchor terminal; or the first serving terminal does not support the role of serving terminal.

In some embodiments of this application, S210 may include:
reselecting, by the terminal device, an anchor terminal when at least one of the following conditions is met:
quality of a channel between the terminal device and a first anchor terminal meets a preset condition;
a distance between the terminal device and the first anchor terminal is greater than a first distance threshold;
information about movement between the terminal device and the first anchor terminal meets a first preset condition; or
the first anchor terminal does not support the role of anchor terminal.

In some embodiments of this application, S210 may include:
reselecting, by the terminal device, a serving terminal when at least one of the following conditions is met:
quality of a channel between the terminal device and a first serving terminal meets a preset condition;
a distance between the terminal device and the first serving terminal is greater than a second distance threshold;
information about movement between the terminal device and the first serving terminal meets a second preset condition; or
the first serving terminal does not support the role of serving terminal.

In some embodiments, that the quality of the channel between the terminal device and the first anchor terminal meets the preset condition may be considered as: the quality of the channel between the terminal device and the first anchor terminal is relatively poor, or in other words, being poor to a specific extent.

Optionally, that the quality of the channel between the terminal device and the first anchor terminal meets the preset condition may include but is not limited to at least one of the following:
the quality of the channel between the terminal device and the first anchor terminal is lower than a first channel quality threshold; or
an amount of change in the quality of the channel between the terminal device and the first anchor terminal within a first time period exceeds a first channel quality change amount threshold.

Optionally, the first channel quality threshold may be predefined, configured by a network device, configured by a serving terminal, or determined by the terminal device.

In some embodiments, the first channel quality threshold may include an RSRP threshold and/or an RSRQ threshold.

Optionally, the first channel quality change amount threshold may be predefined, configured by a network device, configured by a serving terminal, or determined by the terminal device.

In some embodiments, the first channel quality change amount threshold may include an RSRP change amount threshold and/or an RSRQ change amount threshold.

In some embodiments, duration of the first time period may be predefined, configured by a network device, configured by a serving terminal, or determined by the terminal device.

In some embodiments, that the quality of the channel between the terminal device and the first serving terminal meets the preset condition may be considered as: the quality of the channel between the terminal device and the first serving terminal is relatively poor, or in other words, being poor to a specific extent.

Optionally, that the quality of the channel between the terminal device and the first serving terminal meets the preset condition may include at least one of the following:
the quality of the channel between the terminal device and the first serving terminal is lower than a second channel quality threshold; or
an amount of change in the quality of the channel between the terminal device and the first serving terminal within a second time period exceeds a second channel quality change amount threshold.

Optionally, the second channel quality threshold may be predefined, configured by a network device, configured by a serving terminal, or determined by the terminal device.

In some embodiments, the second channel quality threshold may include an RSRP threshold and/or an RSRQ threshold.

Optionally, the second channel quality change amount threshold may be predefined, configured by a network device, configured by a serving terminal, or determined by the terminal device.

In some embodiments, the second channel quality change amount threshold may include an RSRP change amount threshold and/or an RSRQ change amount threshold.

In some embodiments, duration of the second time period may be predefined, configured by a network device, configured by a serving terminal, or determined by the terminal device.

In some embodiments, that the information about movement between the terminal device and the first anchor terminal meets the first preset condition may be considered as: the moving trend between the terminal device and the first anchor terminal is being increasingly far from each other.

Optionally, that the information about movement between the terminal device and the first anchor terminal meets the first preset condition includes but is not limited to at least one of the following:
a moving direction of the terminal device is different from a moving direction of the first anchor terminal; and/or
a relative moving speed between the terminal device and the first anchor terminal is greater than a first speed threshold.

Optionally, that the information about movement between the terminal device and the first anchor terminal meets the first preset condition includes but is not limited to at least one of the following:
a moving direction of the terminal device is the same as a moving direction of the first anchor terminal; and/or
a relative moving speed between the terminal device and the first anchor terminal is greater than a first speed threshold.

Optionally, the first speed threshold may be predefined, configured by a network device, configured by a serving terminal, or determined by the terminal device.

In some embodiments, that the information about movement between the terminal device and the first serving terminal meets the second preset condition may be considered as: the moving trend between the terminal device and the first serving terminal is being increasingly far from each other.

Optionally, that the information about movement between the terminal device and the first serving terminal meets the second preset condition includes but is not limited to at least one of the following:
a moving direction of the terminal device is different from a moving direction of the first serving terminal; and/or
a relative moving speed between the terminal device and the first serving terminal is greater than a second speed threshold.

Optionally, that the information about movement between the terminal device and the first serving terminal meets the second preset condition includes but is not limited to at least one of the following:
a moving direction of the terminal device is the same as a moving direction of the first serving terminal; and/or
a relative moving speed between the terminal device and the first serving terminal is greater than a second speed threshold.

Optionally, the second speed threshold may be predefined, configured by a network device, configured by a serving terminal, or determined by the terminal device.

In some embodiments, that the first anchor terminal does not support the role of anchor terminal includes but is not limited to at least one of the following:
the first anchor terminal does not support providing location information;
the first anchor terminal does not support measuring or receiving a sidelink positioning reference signal transmitted by the terminal device; or
the first anchor terminal does not support transmitting a sidelink positioning reference signal to be measured or received by the terminal device.

In some embodiments, that the first serving terminal does not support the role of serving terminal includes but is not limited to at least one of the following:
the first serving terminal does not support providing a function of calculating a positioning result; or
the first serving terminal does not support allocating a sidelink positioning reference signal resource.

In some embodiments of this application, the method 200 further includes:
determining, by the terminal device based on second information, a reselected target anchor terminal and/or a reselected target serving terminal.

The second information includes at least one of the following:
quality information of a channel between the terminal device and a candidate anchor terminal;
quality information of a channel between the terminal device and a candidate serving terminal;
information about a distance between the terminal device and a candidate anchor terminal;
information about a distance between the terminal device and a candidate serving terminal;
information about movement between the terminal device and a candidate anchor terminal;
information about movement between the terminal device and a candidate serving terminal;
capability information of a candidate anchor terminal; or
capability information of a candidate serving terminal.

Therefore, in this embodiment of this application, the terminal device may determine, based on the second information, the reselected target anchor terminal and/or the reselected target serving terminal, and further perform sidelink positioning based on the reselected target anchor terminal and/or the reselected target serving terminal, which is conducive to ensuring performance of sidelink positioning.

In some embodiments of this application, the determining, by the terminal device based on the second information, the reselected target anchor terminal may include:
the terminal device may determine the reselected target anchor terminal based on at least one of the following information:
quality information of a channel between the terminal device and a candidate anchor terminal;
information about a distance between the terminal device and a candidate anchor terminal;
information about movement between the terminal device and a candidate anchor terminal; or
capability information of a candidate anchor terminal.

That is, the terminal device may reselect a target anchor terminal according to at least one of quality of a signal between the terminal device and a candidate anchor terminal, a distance between the terminal device and the candidate anchor terminal, information about movement between the terminal device and the candidate anchor terminal, or capability information of the candidate anchor terminal, which is conducive to ensuring that the reselected target anchor terminal can provide a relatively good sidelink positioning service, and ensuring performance of sidelink positioning.

In some embodiments of this application, the determining, by the terminal device based on second information, the reselected target serving terminal may include:
the terminal device may determine the reselected target serving terminal based on at least one of the following information:
quality information of a channel between the terminal device and a candidate serving terminal;
information about a distance between the terminal device and a candidate serving terminal;
information about movement between the terminal device and a candidate serving terminal; or
capability information of a candidate serving terminal.

That is, the terminal device may reselect a target serving terminal according to at least one of quality of a signal between the terminal device and a candidate serving terminal, a distance between the terminal device and the candidate serving terminal, information about movement between the terminal device and the candidate serving terminal, or capability information of the candidate serving terminal, which is conducive to ensuring that the reselected target serving terminal can provide a relatively good sidelink positioning service, and ensuring performance of sidelink positioning.

In some embodiments, the target anchor terminal meets at least one of the following conditions:
quality of a channel between the terminal device and the target anchor terminal meets a third preset condition;
information about movement between the terminal device and the target anchor terminal meets a fourth preset condition; or
information about a distance between the terminal device and the target anchor terminal meets a preset condition.

In some embodiments, that the quality of the channel between the terminal device and the target anchor terminal meets the third preset condition may be considered as: the quality of the channel between the terminal device and the target anchor terminal is relatively good (or in other words, being better than a specific extent), or the quality of the channel between the terminal device and the target anchor terminal is better than the quality of the channel between the terminal device and the first anchor terminal by a specific threshold.

Optionally, that the quality of the channel between the terminal device and the target anchor terminal meets the third preset condition includes but is not limited to at least one of the following:
the quality of the channel between the terminal device and the target anchor terminal is higher than or equal to a third channel quality threshold;
the quality of the channel between the terminal device and the target anchor terminal is higher than the quality of the channel between the terminal device and the first anchor terminal by at least a fourth signal quality threshold (or in other words, the quality of the channel between the terminal device and the target anchor terminal is better than the quality of the channel between the terminal device and the first anchor terminal by at least the fourth signal quality threshold); for example, a difference between the quality of the channel between the terminal device and the target anchor terminal and the quality of the channel between the terminal device and the first anchor terminal is greater than or equal to the fourth signal quality threshold;
duration in which the quality of the channel between the terminal device and the target anchor terminal is higher than or equal to the third channel quality threshold reaches a first duration threshold, or in other words, the quality of the channel between the terminal device and the target anchor terminal is higher than or equal to the third channel quality threshold, and duration for which this case lasts reaches the first duration threshold; or
duration in which the quality of the channel between the terminal device and the target anchor terminal is higher than the quality of the channel between the terminal device and the first anchor terminal by at least the fourth signal quality threshold reaches a second duration threshold, or in other words, the quality of the channel between the terminal device and the target anchor terminal is better than the quality of the channel between the terminal device and the first anchor terminal by at least the fourth signal quality threshold, and duration for which this case lasts reaches the second duration threshold.

Optionally, the third channel quality threshold may be predefined, configured by a network device, configured by a serving terminal, or determined by the terminal device.

Optionally, the third channel quality threshold may be determined based on a fixed signal quality threshold and a signal quality offset value (or referred to as a hysteresis value), where the signal quality offset value is a signal quality offset value corresponding to the first anchor terminal, and the signal quality offset value is used to adjust a level of difficulty in reselecting an anchor terminal. By configuring respective signal quality offset values for different anchor terminals, and reselecting an anchor terminal based on the signal quality offset values, a ping-pong effect caused by frequent reselection of an anchor terminal can be avoided.

Optionally, the fourth channel quality threshold may be predefined, configured by a network device, configured by a serving terminal, or determined by the terminal device.

Optionally, the fourth channel quality threshold may be determined based on a fixed signal quality threshold and a signal quality offset value (or referred to as a hysteresis value), where the signal quality offset value is a signal quality offset value corresponding to the first anchor terminal, and the signal quality offset value is used to adjust a level of difficulty in reselecting an anchor terminal. By configuring respective signal quality offset values for different anchor terminals, and reselecting an anchor terminal based on the signal quality offset values, a ping-pong effect caused by frequent reselection of an anchor terminal can be avoided.

Optionally, the first duration threshold may be predefined, configured by a network device, configured by a serving terminal, or determined by the terminal device.

Optionally, the second duration threshold may be predefined, configured by a network device, configured by a serving terminal, or determined by the terminal device.

Optionally, that the information about movement between the terminal device and the target anchor terminal meets the fourth preset condition includes but is not limited to at least one of the following:
a moving direction of the terminal device is the same as a moving direction of the target anchor terminal;
a relative moving speed between the terminal device and the target anchor terminal is less than a third speed threshold; or
a difference between the relative moving speed between the terminal device and the first anchor terminal and the relative moving speed between the terminal device and the target anchor terminal is greater than or equal to a specific speed threshold.

Optionally, that the information about movement between the terminal device and the target anchor terminal meets the fourth preset condition includes but is not limited to at least one of the following:
a moving direction of the terminal device is different from a moving direction of the target anchor terminal;
a relative moving speed between the terminal device and the target anchor terminal is less than a third speed threshold; or
a difference between the relative moving speed between the terminal device and the first anchor terminal and the relative moving speed between the terminal device and the target anchor terminal is greater than or equal to a specific speed threshold.

Optionally, the third speed threshold may be predefined, configured by a network device, configured by a serving terminal, or determined by the terminal device.

In some embodiments, that the information about the distance between the terminal device and the target anchor terminal meets the preset condition may be considered as: the distance between the terminal device and the target anchor terminal is relatively short, or the distance between the target anchor terminal and the terminal device is shorter than the distance between the first anchor terminal and the terminal device.

In some embodiments, that the information about the distance between the terminal device and the target anchor terminal meets the preset condition may include but is not limited to at least one of the following:
a distance between the terminal device and the target anchor terminal is less than a third distance threshold; or
a difference between the distance between the terminal device and the first anchor terminal and the distance between the terminal device and the target anchor terminal is greater than or equal to a specific distance threshold, that is, the target anchor terminal is closer to the terminal device than the first anchor terminal, and a difference between the two distances is greater than a specific distance threshold.

In some embodiments, the third distance threshold or the specific distance threshold may be predefined, configured by a network device, configured by a serving terminal, or determined by the terminal device.

In some embodiments, the target serving terminal meets at least one of the following conditions:
quality of a channel between the terminal device and the target serving terminal meets a fifth preset condition;
information about movement between the terminal device and the target serving terminal meets a sixth preset condition; or
information about a distance between the terminal device and the target serving terminal meets a preset condition.

In some embodiments, that the quality of the channel between the terminal device and the target serving terminal meets the fifth preset condition may be considered as: the quality of the channel between the terminal device and the target serving terminal is relatively good (or in other words, being better than a specific extent), or the quality of the channel between the terminal device and the target serving terminal is better than the quality of the channel between the terminal device and the first serving terminal by at least a specific threshold.

Optionally, that the quality of the channel between the terminal device and the target serving terminal meets the fifth preset condition includes but is not limited to at least one of the following:
the quality of the channel between the terminal device and the target serving terminal is greater than or equal to a fifth channel quality threshold;
the quality of the channel between the terminal device and the target serving terminal is higher than the quality of the channel between the terminal device and the first serving terminal by at least a sixth signal quality threshold (or in other words, the quality of the channel between the terminal device and the target serving terminal is better than the quality of the channel between the terminal device and the first serving terminal by at least the sixth signal quality threshold); for example, a difference between the quality of the channel between the terminal device and the target serving terminal and the quality of the channel between the terminal device and the first serving terminal is greater than or equal to the sixth signal quality threshold;
duration in which the quality of the channel between the terminal device and the target serving terminal is higher than or equal to the fifth channel quality threshold reaches a third duration threshold, or in other words, the quality of the channel between the terminal device and the target serving terminal is higher than or equal to the fifth channel quality threshold, and duration for which this case lasts reaches the third duration threshold; or
duration in which the quality of the channel between the terminal device and the target serving terminal is higher than the quality of the channel between the terminal device and the first serving terminal by a sixth signal quality threshold reaches a fourth duration threshold, or in other words, the quality of the channel between the terminal device and the target serving terminal is better than the quality of the channel between the terminal device and the first serving terminal by the sixth signal quality threshold, and duration for which this case lasts reaches the fourth duration threshold.

Optionally, the fifth channel quality threshold may be predefined, configured by a network device, configured by a serving terminal, or determined by the terminal device.

Optionally, the fifth channel quality threshold may be determined based on a fixed signal quality threshold and a signal quality offset value (or referred to as a hysteresis value), where the signal quality offset value is a signal quality offset value corresponding to the first serving terminal, and the signal quality offset value is used to adjust a level of difficulty in reselecting a serving terminal. By configuring respective signal quality offset values for different serving terminals, and reselecting a serving terminal based on the signal quality offset values, a ping-pong effect caused by frequent reselection of a serving terminal can be avoided.

Optionally, the sixth channel quality threshold may be predefined, configured by a network device, configured by a serving terminal, or determined by the terminal device.

Optionally, the sixth channel quality threshold may be determined based on a fixed signal quality threshold and a signal quality offset value (or referred to as a hysteresis value), where the signal quality offset value is a signal quality offset value corresponding to the first serving terminal, and the signal quality offset value is used to adjust a level of difficulty in reselecting a serving terminal. By configuring respective signal quality offset values for different serving terminals, and reselecting a serving terminal based on the signal quality offset values, a ping-pong effect caused by frequent reselection of a serving terminal can be avoided.

Optionally, the third duration threshold may be predefined, configured by a network device, configured by a serving terminal, or determined by the terminal device.

Optionally, the fourth duration threshold may be predefined, configured by a network device, configured by a serving terminal, or determined by the terminal device.

In some embodiments, that the information about movement between the terminal device and the target serving terminal meets the sixth preset condition includes but is not limited to at least one of the following:
a moving direction of the terminal device is the same as a moving direction of the target serving terminal;
a relative moving speed between the terminal device and the target serving terminal is less than a fourth speed threshold; or
a difference between the relative moving speed between the terminal device and the first serving terminal and the relative moving speed between the terminal device and the target serving terminal is greater than or equal to a specific speed threshold.

In some embodiments, that the information about movement between the terminal device and the target serving terminal meets the sixth preset condition includes but is not limited to at least one of the following:
a moving direction of the terminal device is different from a moving direction of the target serving terminal;
a relative moving speed between the terminal device and the target serving terminal is less than a fourth speed threshold; or
a difference between the relative moving speed between the terminal device and the first serving terminal and the relative moving speed between the terminal device and the target serving terminal is greater than or equal to a specific speed threshold.

Optionally, the fourth speed threshold may be predefined, configured by a network device, configured by a serving terminal, or determined by the terminal device.

In some embodiments, that the information about the distance between the terminal device and the target serving terminal meets the preset condition may be considered as: the distance between the terminal device and the target serving terminal is relatively short, or the distance between the target serving terminal and the terminal device is shorter than the distance between the first serving terminal and the terminal device.

In some embodiments, that the information about the distance between the terminal device and the target serving terminal meets the preset condition may include but is not limited to at least one of the following:
a distance between the terminal device and the target serving terminal is less than a fourth distance threshold; or
a difference between the distance between the terminal device and the first serving terminal and the distance between the terminal device and the target serving terminal is greater than or equal to a specific distance threshold, that is, the target serving terminal is closer to the terminal device than the first serving terminal, and a difference between the two distances is greater than a specific distance threshold.

In some embodiments, the fourth distance threshold or the specific distance threshold may be predefined, configured by a network device, configured by a serving terminal, or determined by the terminal device.

In some embodiments of this application, the method 200 further includes:

S201: A network device or a serving terminal transmits first configuration information to the terminal device, where the first configuration information is used to configure a reselection parameter of an anchor terminal and/or a reselection parameter of a serving terminal.

In some embodiments, the first configuration information may be used to configure at least one of the following:
a parameter used to trigger anchor terminal reselection;
a parameter used to trigger serving terminal reselection;
a parameter used to reselect a target anchor terminal; or
a parameter used to reselect a target serving terminal.

In some embodiments, the first configuration information is used to configure at least one of the following parameters:
a signal quality threshold used to trigger anchor terminal reselection, for example, the first channel quality threshold or the first signal quality change amount threshold;
a distance threshold used to trigger anchor terminal reselection, for example, the first distance threshold;
a moving speed threshold used to trigger anchor terminal reselection, for example, the first speed threshold;
a signal quality threshold used to trigger anchor terminal reselection, for example, the second signal quality threshold or the second signal quality change amount threshold;
a distance threshold used to trigger serving terminal reselection, for example, the second distance threshold;
a moving speed threshold used to trigger serving terminal reselection, for example, the second speed threshold;
a signal quality threshold used to reselect a target anchor terminal, for example, the third signal quality threshold or the fourth signal quality threshold;
a distance threshold used to reselect a target anchor terminal, for example, the third distance threshold;
a speed threshold used to reselect a target anchor terminal, for example, the third speed threshold;
a signal quality threshold used to reselect a target serving terminal, for example, the fifth signal quality threshold or the sixth signal quality threshold;
a distance threshold used to reselect a target serving terminal, for example, the fourth distance threshold; or
a speed threshold used to reselect a target serving terminal, for example, the fourth speed threshold.

In some embodiments, when the network device or the serving terminal configures only some of the parameters, the other parameters may be predefined, or may be determined by the terminal device.

In conclusion, in this embodiment of this application, the terminal device may reselect an anchor terminal and/or a serving terminal under a specific condition, which is conducive to ensuring performance of sidelink positioning.

For example, the terminal device may determine whether to trigger reselection of an anchor terminal, based on at least one of quality of a signal between the terminal device and an anchor terminal, a distance between the terminal device and the anchor terminal, information about movement between the terminal device and the anchor terminal, or capability information of the anchor terminal, which is conducive to ensuring that the currently used anchor terminal can provide a relatively good sidelink positioning service, and ensuring performance of sidelink positioning.

For another example, the terminal device may determine whether to trigger reselection of a serving terminal, based on at least one of quality of a signal between the terminal device and a serving terminal, a distance between the terminal device and the serving terminal, information about movement between the terminal device and the serving terminal, or capability information of the serving terminal, which is conducive to ensuring that the currently used serving terminal can provide a relatively good sidelink positioning service, and ensuring performance of sidelink positioning.

Further, the terminal device may reselect a target anchor terminal according to at least one of quality of a signal between the terminal device and a candidate anchor terminal, a distance between the terminal device and the candidate anchor terminal, information about movement between the terminal device and the candidate anchor terminal, or capability information of the candidate anchor terminal, which is conducive to ensuring that the reselected target anchor terminal can provide a relatively good sidelink positioning service, and ensuring performance of sidelink positioning.

The terminal device may further reselect a target serving terminal according to at least one of quality of a signal between the terminal device and a candidate serving terminal, a distance between the terminal device and the candidate serving terminal, information about movement between the terminal device and the candidate serving terminal, or capability information of the candidate serving terminal, which is conducive to ensuring that the reselected target serving terminal can provide a relatively good sidelink positioning service, and ensuring performance of sidelink positioning.

The foregoing describes the method embodiments of this application in detail with reference to FIG. 4. The following describes the apparatus embodiments of this application in detail with reference to FIG. 5 to FIG. 9. It should be understood that the apparatus embodiments correspond to the method embodiments. For similar descriptions, refer to the method embodiments.

FIG. 5 shows a schematic block diagram of a terminal device 400 according to an embodiment of this application. As shown in FIG. 5, the terminal device 400 includes:
a processing unit 410, configured to: in a case in which a first condition is met, reselect an anchor terminal used for sidelink positioning and/or a serving terminal used to determine a positioning result.

In some embodiments, the processing unit 410 is further configured to:
determine, based on first information, whether to reselect the anchor terminal used for sidelink positioning and/or the serving terminal used to determine the positioning result.

The first information includes at least one of the following:
quality information of a channel between the terminal device and a first anchor terminal, where the first anchor terminal is an anchor terminal currently used by the terminal device for sidelink positioning;
quality information of a channel between the terminal device and a first serving terminal, where the first serving terminal is a serving terminal currently used by the terminal device to determine a positioning result;
information about a distance between the terminal device and the first anchor terminal;
information about a distance between the terminal device and the first serving terminal;
information about movement between the terminal device and the first anchor terminal;
information about movement between the terminal device and the first serving terminal;
capability information or capability change information of the first anchor terminal; or
capability information or capability change information of the first serving terminal.

In some embodiments, the information about movement between the terminal device and the first anchor terminal includes:
information about a moving direction between the terminal device and the first anchor terminal; and/or
information about a moving speed between the terminal device and the first anchor terminal.

In some embodiments, the information about movement between the terminal device and the first serving terminal includes:
information about a moving direction between the terminal device and the first serving terminal; and/or
information about a moving speed between the terminal device and the first serving terminal.

In some embodiments, the capability information or the capability change information of the first anchor terminal includes: whether the first anchor terminal supports a role of anchor terminal.

In some embodiments, whether the first anchor terminal supports the role of anchor terminal includes at least one of the following:
whether the first anchor terminal supports providing location information of the first anchor terminal;
whether the first anchor terminal supports measuring or receiving a sidelink positioning reference signal transmitted by the terminal device; or
whether the first anchor terminal supports transmitting a sidelink positioning reference signal to be measured by the terminal device.

In some embodiments, the capability information or the capability change information of the first serving terminal includes: whether the first serving terminal supports a role of serving terminal.

In some embodiments, whether the first serving terminal supports the role of serving terminal includes at least one of the following:
whether the first serving terminal supports providing a function of calculating a positioning result; or
whether the first serving terminal supports allocating a sidelink positioning reference signal SL-PRS resource.

In some embodiments, the first condition includes at least one of the following:
quality of a channel between the terminal device and a first anchor terminal is lower than a first channel quality threshold;
an amount of change in quality of a channel between the terminal device and a first anchor terminal within a first time period exceeds a first channel quality change amount threshold;
quality of a channel between the terminal device and a first serving terminal is lower than a second channel quality threshold;
an amount of change in quality of a channel between the terminal device and a first serving terminal within a second time period exceeds a second channel quality change amount threshold;
a distance between the terminal device and a first anchor terminal is greater than a first distance threshold;
a distance between the terminal device and a first serving terminal is greater than a second distance threshold;
information about movement between the terminal device and a first anchor terminal meets a first preset condition;
information about movement between the terminal device and a first serving terminal meets a second preset condition;
the first anchor terminal does not support a role of anchor terminal; or the first serving terminal does not support a role of serving terminal.

In some embodiments, that the information about movement between the terminal device and the first anchor terminal meets the first preset condition includes:
a moving direction of the terminal device is different from a moving direction of the first anchor terminal; and/or
a relative moving speed between the terminal device and the first anchor terminal is greater than a first speed threshold.

In some embodiments, that the information about movement between the terminal device and the first anchor terminal meets the first preset condition includes:
a moving direction of the terminal device is the same as a moving direction of the first anchor terminal; and/or
a relative moving speed between the terminal device and the first anchor terminal is greater than a first speed threshold.

In some embodiments, that the information about movement between the terminal device and the first serving terminal meets the second preset condition includes:
a moving direction of the terminal device is different from a moving direction of the first serving terminal; and/or
a relative moving speed between the terminal device and the first serving terminal is greater than a second speed threshold.

In some embodiments, that the information about movement between the terminal device and the first serving terminal meets the second preset condition includes:
a moving direction of the terminal device is the same as a moving direction of the first serving terminal; and/or
a relative moving speed between the terminal device and the first serving terminal is greater than a second speed threshold.

In some embodiments, that the first anchor terminal does not support the role of anchor terminal includes at least one of the following:
the first anchor terminal does not support providing location information;
the first anchor terminal does not support measuring or receiving a sidelink positioning reference signal transmitted by the terminal device; or
the first anchor terminal does not support transmitting a sidelink positioning reference signal to be measured by the terminal device.

In some embodiments, that the first serving terminal does not support the role of serving terminal includes at least one of the following:
the first serving terminal does not support providing a function of calculating a positioning result; or
the first serving terminal does not support allocating a sidelink positioning reference signal SL-PRS resource.

In some embodiments, the processing unit 410 is further configured to:
determine, based on second information, a reselected target anchor terminal used for sidelink positioning and/or a reselected target serving terminal used to determine a positioning result.

The second information includes at least one of the following:
quality information of a channel between the terminal device and a candidate anchor terminal;
quality information of a channel between the terminal device and a candidate serving terminal;
information about a distance between the terminal device and a candidate anchor terminal;
information about a distance between the terminal device and a candidate serving terminal;
information about movement between the terminal device and a candidate anchor terminal;
information about movement between the terminal device and a candidate serving terminal;
capability information of a candidate anchor terminal; or
capability information of a candidate serving terminal.

In some embodiments, quality of a channel between the terminal device and the target anchor terminal meets a third preset condition; and/or
information about movement between the terminal device and the target anchor terminal meets a fourth preset condition; and/or
a distance between the terminal device and the target anchor terminal is less than a third distance threshold.

In some embodiments, that the quality of the channel between the terminal device and the target anchor terminal meets the third preset condition includes at least one of the following:
the quality of the channel between the terminal device and the target anchor terminal is higher than a third channel quality threshold;
the quality of the channel between the terminal device and the target anchor terminal is higher than quality of a channel between the terminal device and a first anchor terminal by at least a fourth signal quality threshold;
duration in which the quality of the channel between the terminal device and the target anchor terminal is higher than a third channel quality threshold reaches a first duration threshold; or
duration in which the quality of the channel between the terminal device and the target anchor terminal is higher than quality of a channel between the terminal device and a first anchor terminal by at least a fourth signal quality threshold reaches a second duration threshold.

In some embodiments, that the information about movement between the terminal device and the target anchor terminal meets the fourth preset condition includes:
a moving direction of the terminal device is the same as a moving direction of the target anchor terminal;
a relative moving speed between the terminal device and the target anchor terminal is less than a third speed threshold.

In some embodiments, that the information about movement between the terminal device and the target anchor terminal meets the fourth preset condition includes:
a moving direction of the terminal device is different from a moving direction of the target anchor terminal;
a relative moving speed between the terminal device and the target anchor terminal is less than a third speed threshold.

In some embodiments, quality of a channel between the terminal device and the target serving terminal meets a fifth preset condition; and/or
information about movement between the terminal device and the target serving terminal meets a sixth preset condition; and/or
a distance between the terminal device and the target serving terminal is less than a fourth distance threshold.

In some embodiments, that the quality of the channel between the terminal device and the target serving terminal meets the fifth preset condition includes at least one of the following:
the quality of the channel between the terminal device and the target serving terminal is higher than a fifth channel quality threshold;
the quality of the channel between the terminal device and the target serving terminal is higher than quality of a channel between the terminal device and a first serving terminal by at least a sixth signal quality threshold;
duration in which the quality of the channel between the terminal device and the target serving terminal is higher than a fifth channel quality threshold reaches a third duration threshold; or
duration in which the quality of the channel between the terminal device and the target serving terminal is higher than quality of a channel between the terminal device and a first serving terminal by at least a sixth signal quality threshold reaches a fourth duration threshold.

In some embodiments, that the information about movement between the terminal device and the target serving terminal meets the sixth preset condition includes:
a moving direction of the terminal device is the same as a moving direction of the target serving terminal;
a relative moving speed between the terminal device and the target serving terminal is less than a fourth speed threshold.

In some embodiments, that the information about movement between the terminal device and the target serving terminal meets the sixth preset condition includes:
a moving direction of the terminal device is different from a moving direction of the target serving terminal;
a relative moving speed between the terminal device and the target serving terminal is less than a fourth speed threshold.

In some embodiments, the terminal device 400 further includes:
a communications unit, configured to receive first configuration information transmitted by a network device, where the first configuration information is used to configure a reselection parameter of the anchor terminal and/or a reselection parameter of the serving terminal.

In some embodiments, the first configuration information is used to configure at least one of the following:
a parameter used to trigger anchor terminal reselection;
a parameter used to trigger serving terminal reselection;
a parameter used to reselect a target anchor terminal; or
a parameter used to reselect a target serving terminal.

In some embodiments, the first configuration information is used to configure at least one of the following parameters:
a signal quality threshold used to trigger anchor terminal reselection;
a distance threshold used to trigger anchor terminal reselection;
a moving speed threshold used to trigger anchor terminal reselection;
a signal quality threshold used to trigger serving terminal reselection;
a distance threshold used to trigger serving terminal reselection;
a moving speed threshold used to trigger serving terminal reselection;
a signal quality threshold used to reselect a target anchor terminal;
a distance threshold used to reselect a target anchor terminal;
a speed threshold used to reselect a target anchor terminal;
a signal quality threshold used to reselect a target serving terminal;
a distance threshold used to reselect a target serving terminal; or
a speed threshold used to reselect a target serving terminal.

Optionally, in some embodiments, the communications module may be a communications interface or a transceiver, or an input/output interface of a communications chip or a system-on-chip. The determining module may be one or more processors.

It should be understood that the terminal device 400 according to this embodiment of this application may correspond to the terminal device in the method embodiments of this application, and the foregoing and other operations and/or functions of the units in the terminal device 400 are used to implement corresponding procedures of the terminal device in the method 200 shown in FIG. 4. For brevity, details are not described herein again.

FIG. 6 is a schematic block diagram of a network device according to an embodiment of this application. The network device 500 in FIG. 6 includes:
a communications unit 510, configured to transmit first configuration information to a terminal device, where the first configuration information is used to configure a reselection parameter of an anchor terminal and/or a reselection parameter of a serving terminal.

In some embodiments, the first configuration information is used to configure at least one of the following:
a parameter used to trigger anchor terminal reselection;
a parameter used to trigger serving terminal reselection;
a parameter used to reselect a target anchor terminal; or
a parameter used to reselect a target serving terminal.

In some embodiments, the first configuration information is used to configure at least one of the following parameters:
a signal quality threshold used to trigger anchor terminal reselection;
a distance threshold used to trigger anchor terminal reselection;
a moving speed threshold used to trigger anchor terminal reselection;
a signal quality threshold used to trigger serving terminal reselection;
a distance threshold used to trigger serving terminal reselection;
a moving speed threshold used to trigger serving terminal reselection;
a signal quality threshold used to reselect a target anchor terminal;
a distance threshold used to reselect a target anchor terminal;
a speed threshold used to reselect a target anchor terminal;
a signal quality threshold used to reselect a target serving terminal;
a distance threshold used to reselect a target serving terminal; or
a speed threshold used to reselect a target serving terminal.

Optionally, in some embodiments, the communications unit may be a communications interface or a transceiver, or an input/output interface of a communications chip or a system-on-chip. The processing unit may be one or more processors.

It should be understood that the network device 500 according to this embodiment of this application may correspond to the network device in the method embodiments of this application, and the foregoing and other operations and/or functions of the units in the network device 500 are separately used to implement a corresponding procedure of the network device in the method 200 shown in FIG. 4. For brevity, details are not described herein again.

FIG. 7 is a schematic structural diagram of a communications device 600 according to an embodiment of this application. The communications device 600 shown in FIG. 7 includes a processor 610, and the processor 610 may invoke a computer program from a memory and run the computer program to implement a method in embodiments of this application.

Optionally, as shown in FIG. 7, the communications device 600 may further include a memory 620. The processor 610 may invoke a computer program from the memory 620 and run the computer program to implement a method in embodiments of this application.

The memory 620 may be a separate component separate from the processor 610, or may be integrated into the processor 610.

Optionally, as shown in FIG. 7, the communications device 600 may further include a transceiver 630. The processor 610 may control the transceiver 630 to communicate with another device. Specifically, information or data may be transmitted to another device, or information or data transmitted by another device may be received.

The transceiver 630 may include a transmitter and a receiver. The transceiver 630 may further include an antenna, and there may be one or more antennas.

Optionally, the communications device 600 may be a network device in embodiments of this application, and the communications device 600 may implement a corresponding procedure implemented by the network device in a method in embodiments of this application. For brevity, details are not described herein again.

Optionally, the communications device 600 may be specifically a mobile terminal or a terminal device in embodiments of this application, and the communications device 600 may implement a corresponding procedure implemented by the mobile terminal or the terminal device in a method in embodiments of this application. For brevity, details are not described herein again.

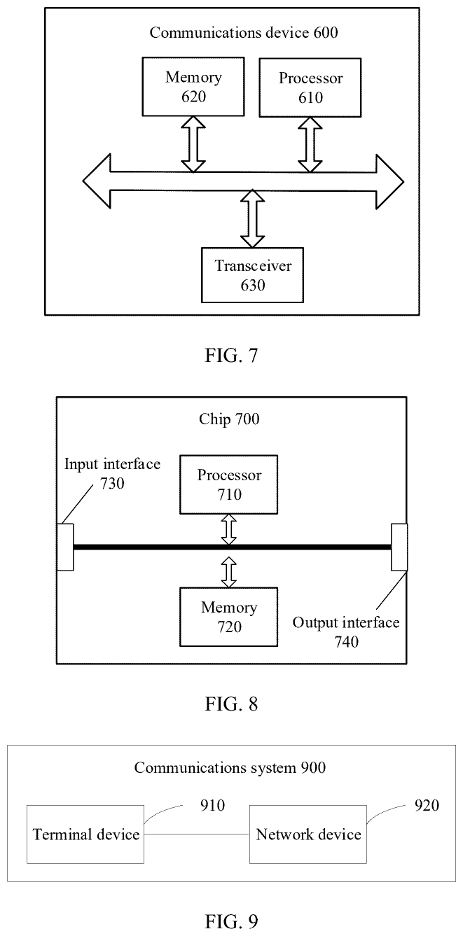

FIG. 8 is a schematic structural diagram of a chip according to an embodiment of this application. The chip 700 shown in FIG. 8 includes a processor 710, and the processor 710 may invoke a computer program from a memory and run the computer program to implement a method in embodiments of this application.

Optionally, as shown in FIG. 8, the chip 700 may further include a memory 720. The processor 710 may invoke a computer program from the memory 720 and run the computer program to implement a method in embodiments of this application.

The memory 720 may be a separate component separate from the processor 710, or may be integrated into the processor 710.

Optionally, the chip 700 may further include an input interface 730. The processor 710 may control the input interface 730 to communicate with another device or chip. Specifically, information or data transmitted by the another device or chip may be acquired.

Optionally, the chip 700 may further include an output interface 740. The processor 710 may control the output interface 740 to communicate with another device or chip. Specifically, the processor 710 may output information or data to the another device or chip.

Optionally, the chip may be applied to a network device in embodiments of this application, and the chip may implement a corresponding procedure implemented by the network device in a method in embodiments of this application. For brevity, details are not described herein again.

Optionally, the chip may be applied to a mobile terminal or a terminal device in embodiments of this application, and the chip may implement a corresponding procedure implemented by the mobile terminal or the terminal device in a method in embodiments of this application. For brevity, details are not described herein again.

It should be understood that the chip mentioned in this embodiment of this application may also be referred to as a system-level chip, a system chip, a chip system, or a system-on-chip.

FIG. 9 is a schematic block diagram of a communications system 900 according to an embodiment of this application. As shown in FIG. 9, the communications system 900 includes a terminal device 910 and a network device 920.

The terminal device 910 may be used to implement the corresponding functions implemented by the terminal device in the foregoing methods, and the network device 920 may be used to implement the corresponding functions implemented by the network device in the foregoing methods. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in embodiments of this application includes but is not limited to these memories and any memory of another proper type.

An embodiment of this application further provides a computer-readable storage medium, configured to store a computer program.

Optionally, the computer-readable storage medium may be applied to a network device in embodiments of this application, and the computer program causes a computer to execute a corresponding procedure implemented by the network device in a method in embodiments of this application. For brevity, details are not described herein again.

Optionally, the computer-readable storage medium may be applied to a mobile terminal or a terminal device in embodiments of this application, and the computer program causes a computer to execute a corresponding procedure implemented by the mobile terminal or the terminal device in a method in embodiments of this application. For brevity, details are not described herein again.

An embodiment of this application further provides a computer program product, including computer program instructions.

Optionally, the computer program product may be applied to a network device in embodiments of this application, and the computer program instructions cause a computer to execute a corresponding procedure implemented by the network device in a method in embodiments of this application. For brevity, details are not described herein again.

Optionally, the computer program product may be applied to a mobile terminal or a terminal device in embodiments of this application, and the computer program instructions cause a computer to execute a corresponding procedure implemented by the mobile terminal or the terminal device in a method in embodiments of this application. For brevity, details are not described herein again.

An embodiment of this application further provides a computer program.

Optionally, the computer program may be applied to a network device in embodiments of this application. When the computer program runs on a computer, the computer executes a corresponding procedure implemented by the network device in a method in embodiments of this application. For brevity, details are not described herein again.

Optionally, the computer program may be applied to a mobile terminal or a terminal device in embodiments of this application. When the computer program runs on a computer, the computer executes a corresponding procedure implemented by the mobile terminal or the terminal device in a method in embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of this application.

Those skilled in the art may clearly understand that, for the purpose of convenient and brief description, for detailed working processes of the foregoing system, apparatus, and unit, refer to the corresponding processes in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions in embodiments of this application essentially, or the part contributing to a conventional technology, or some of the technical solutions may be implemented in a form of a software product. The computer software product is stored in a storage medium and includes several instructions for instructing a computer device (which may be a personal computer, a server, a network device, or the like) to execute all or some of the steps of a method in embodiments of this application. The foregoing storage medium includes any medium that can store program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A wireless communication method, comprising:
reselecting, by a terminal device in a case in which a first condition is met, an anchor terminal used for sidelink positioning and/or a serving terminal used to determine a positioning result.

2. The method according to claim 1, wherein the method further comprises:
determining, based on first information, whether to reselect the anchor terminal used for sidelink positioning and/or the serving terminal used to determine the positioning result,
wherein the first information comprises at least one of following:
quality information of a channel between the terminal device and a first anchor terminal, wherein the first anchor terminal is an anchor terminal currently used by the terminal device for sidelink positioning;
quality information of a channel between the terminal device and a first serving terminal, wherein the first serving terminal is a serving terminal currently used by the terminal device to determine a positioning result;
information about a distance between the terminal device and the first anchor terminal;
information about a distance between the terminal device and the first serving terminal;
information about movement between the terminal device and the first anchor terminal;
information about movement between the terminal device and the first serving terminal;
capability information or capability change information of the first anchor terminal; or
capability information or capability change information of the first serving terminal.

3. The method according to claim 2, wherein the capability information or the capability change information of the first anchor terminal comprises: whether the first anchor terminal supports a role of anchor terminal.

4. The method according to claim 3, wherein whether the first anchor terminal supports the role of anchor terminal comprises at least one of following:
whether the first anchor terminal supports providing location information of the first anchor terminal;
whether the first anchor terminal supports measuring or receiving a sidelink positioning reference signal transmitted by the terminal device; or
whether the first anchor terminal supports transmitting a sidelink positioning reference signal to be measured by the terminal device.

5. The method according to claim 2, wherein the capability change information of the first serving terminal comprises: whether the first serving terminal supports a role of serving terminal.

6. The method according to claim 5, wherein whether the first serving terminal supports the role of serving terminal comprises at least one of following:
whether the first serving terminal supports providing a function of calculating a positioning result; or
whether the first serving terminal supports allocating a sidelink positioning reference signal resource.

7. The method according to claim 1, wherein the first condition comprises at least one of following:
quality of a channel between the terminal device and a first anchor terminal is lower than a first channel quality threshold;
an amount of change in quality of a channel between the terminal device and a first anchor terminal within a first time period exceeds a first channel quality change amount threshold;
quality of a channel between the terminal device and a first serving terminal is lower than a second channel quality threshold;
an amount of change in quality of a channel between the terminal device and a first serving terminal within a second time period exceeds a second channel quality change amount threshold;
a distance between the terminal device and a first anchor terminal is greater than a first distance threshold;
a distance between the terminal device and a first serving terminal is greater than a second distance threshold;
information about movement between the terminal device and a first anchor terminal meets a first preset condition;
information about movement between the terminal device and a first serving terminal meets a second preset condition;
the first anchor terminal does not support a role of anchor terminal; or
the first serving terminal does not support a role of serving terminal.

8. The method according to claim 7, wherein that the first anchor terminal does not support the role of anchor terminal comprises at least one of following:
the first anchor terminal does not support providing location information;
the first anchor terminal does not support measuring or receiving a sidelink positioning reference signal transmitted by the terminal device; or
the first anchor terminal does not support transmitting a sidelink positioning reference signal to be measured by the terminal device.

9. The method according to claim 7, wherein that the first serving terminal does not support the role of serving terminal comprises at least one of following:
the first serving terminal does not support providing a function of calculating a positioning result; or
the first serving terminal does not support allocating a sidelink positioning reference signal resource.

10. The method according to claim 1, wherein the method further comprises:
determining, by the terminal device based on second information, a reselected target anchor terminal used for sidelink positioning and/or a reselected target serving terminal used to determine a positioning result,
wherein the second information comprises at least one of following:
quality information of a channel between the terminal device and a candidate anchor terminal;
quality information of a channel between the terminal device and a candidate serving terminal;
information about a distance between the terminal device and a candidate anchor terminal;
information about a distance between the terminal device and a candidate serving terminal;
information about movement between the terminal device and a candidate anchor terminal;
information about movement between the terminal device and a candidate serving terminal;
capability information of a candidate anchor terminal; or
capability information of a candidate serving terminal.

11. The method according to claim 10, wherein
quality of a channel between the terminal device and the target anchor terminal meets a third preset condition; and/or
information about movement between the terminal device and the target anchor terminal meets a fourth preset condition; and/or
a distance between the terminal device and the target anchor terminal is less than a third distance threshold.

12. The method according to claim 11, wherein that the quality of the channel between the terminal device and the target anchor terminal meets the third preset condition comprises at least one of following:
the quality of the channel between the terminal device and the target anchor terminal is higher than a third channel quality threshold;
the quality of the channel between the terminal device and the target anchor terminal is higher than quality of a channel between the terminal device and a first anchor terminal by at least a fourth signal quality threshold;
duration in which the quality of the channel between the terminal device and the target anchor terminal is higher than a third channel quality threshold reaches a first duration threshold; or
duration in which the quality of the channel between the terminal device and the target anchor terminal is higher than quality of a channel between the terminal device and a first anchor terminal by at least a fourth signal quality threshold reaches a second duration threshold.

13. The method according to claim 10, wherein
quality of a channel between the terminal device and the target serving terminal meets a fifth preset condition; and/or
information about movement between the terminal device and the target serving terminal meets a sixth preset condition; and/or
a distance between the terminal device and the target serving terminal is less than a fourth distance threshold.

14. The method according to claim 13, wherein that the quality of the channel between the terminal device and the target serving terminal meets the fifth preset condition comprises at least one of following:
the quality of the channel between the terminal device and the target serving terminal is higher than a fifth channel quality threshold;
the quality of the channel between the terminal device and the target serving terminal is higher than quality of a channel between the terminal device and a first serving terminal by at least a sixth signal quality threshold;
duration in which the quality of the channel between the terminal device and the target serving terminal is higher than a fifth channel quality threshold reaches a third duration threshold; or
duration in which the quality of the channel between the terminal device and the target serving terminal is higher than quality of a channel between the terminal device and a first serving terminal by at least a sixth signal quality threshold reaches a fourth duration threshold.

15. The method according to claim 1, wherein the method further comprises:
receiving, by the terminal device, first configuration information transmitted by a network device, wherein the first configuration information is used to configure a reselection parameter of the anchor terminal and/or a reselection parameter of the serving terminal.

16. The method according to claim 15, wherein the first configuration information is used to configure at least one of following:
a parameter used to trigger anchor terminal reselection;
a parameter used to trigger serving terminal reselection;
a parameter used to reselect a target anchor terminal; or
a parameter used to reselect a target serving terminal.

17. The method according to claim 15, wherein the first configuration information is used to configure at least one of following parameters:
a signal quality threshold used to trigger anchor terminal reselection;
a distance threshold used to trigger anchor terminal reselection;
a moving speed threshold used to trigger anchor terminal reselection;
a signal quality threshold used to trigger serving terminal reselection;
a distance threshold used to trigger serving terminal reselection;
a moving speed threshold used to trigger serving terminal reselection;
a signal quality threshold used to reselect a target anchor terminal;
a distance threshold used to reselect a target anchor terminal;
a speed threshold used to reselect a target anchor terminal;
a signal quality threshold used to reselect a target serving terminal;
a distance threshold used to reselect a target serving terminal; or
a speed threshold used to reselect a target serving terminal.

18. A wireless communication method, comprising:
transmitting, by a network device, first configuration information to a terminal device, wherein the first configuration information is used to configure a reselection parameter of an anchor terminal and/or a reselection parameter of a serving terminal.

19. The method according to claim 18, wherein the first configuration information is used to configure at least one of following:
a parameter used to trigger anchor terminal reselection;
a parameter used to trigger serving terminal reselection;
a parameter used to reselect a target anchor terminal; or
a parameter used to reselect a target serving terminal; and/or
wherein the first configuration information is used to configure at least one of following parameters:
a signal quality threshold used to trigger anchor terminal reselection;
a distance threshold used to trigger anchor terminal reselection;
a moving speed threshold used to trigger anchor terminal reselection;
a signal quality threshold used to trigger serving terminal reselection;
a distance threshold used to trigger serving terminal reselection;
a moving speed threshold used to trigger serving terminal reselection;
a signal quality threshold used to reselect a target anchor terminal;
a distance threshold used to reselect a target anchor terminal;
a speed threshold used to reselect a target anchor terminal;
a signal quality threshold used to reselect a target serving terminal;
a distance threshold used to reselect a target serving terminal; or
a speed threshold used to reselect a target serving terminal.

20. A terminal device, comprising:
a processor, configured to: in a case in which a first condition is met, reselect an anchor terminal used for sidelink positioning and/or a serving terminal used to determine a positioning result.
